(19) United States
(12) Patent Application Publication
(10) Pub. No.: US 2012/0235385 A1
(43) Pub. Date: Sep. 20, 2012

(54) CARRIAGE

(76) Inventors: Andrew Simpson, Redfern (AU); Jonathan Blake, Redfern (AU); Davida Michelle Sweeney, Surry Hills (AU)

(21) Appl. No.: 13/049,254

(22) Filed: Mar. 16, 2011

(51) Int. Cl. B62B 7/00

(52) U.S. Cl. 280/647; 280/639

(57) ABSTRACT

A carriage including: a frame (12) collapsible from an open configuration to a closed configuration, the frame having a base (18) supported by wheels (16, 18, 20, 22) and a pair of longitudinally extending side members (24, 26) attached to the base, each side member having a major direction of extension with the directions being generally parallel and extending upward and rearward with respect to the base; locking means (30) for securing the frame in the open configuration; a handle (28) extending between the side members and remote the base, the handle operatively associated with the locking means for unlocking the frame; and carrying means securable to the frame to carry an item to be transported, wherein the handle is pivotably connected to one said side member such that in use, the handle upon actuation by a user unlocks the locking means moving the frame from the open configuration to the closed configuration and wherein in the closed configuration the handle is substantially parallel and adjacent the side members.

### FIELD OF THE INVENTION

The present invention relates to a carriage for transporting an item, and in particular, a collapsible stroller for transporting a child.

### BACKGROUND OF THE INVENTION

Carriages are commonly used for transporting or carrying items. One type of carriage is a stroller which is typically used for transporting children. Strollers come in all different variations. One type of commonly used stroller is an umbrella stroller.

Umbrella strollers are generally designed for toddlers or small children. The umbrella stroller typically includes a cloth or vinyl seat suspended from a basic frame having wheels. The seat is configured to accommodate a child in a sitting position and facing forward during transportation. Umbrella strollers are so-called because of their curling double handles that resemble umbrella handles, and their ability to fold up into a small package. Whilst most umbrella strollers are collapsible, the method to collapse them can be cumbersome and requires two hands. This can be problematic especially for a parent who may have to hold the child or bags while collapsing the stroller. Additionally, the double handle design requires two hands (one on each handle) to effectively steer the stroller.

Umbrella strollers are typically light weight and inexpensive. This makes them favourable over other types of strollers which are heavy and expensive. However, the majority of umbrella strollers in the market are made from plastic, alloy, aluminium, steel or the like. All of these materials are man-made and require a great deal of energy to produce. Additionally, the manufacturing and disposal of such materials produces unwanted pollution. Consequently, purchasing a stroller made from these materials indirectly contributes to the environmental degradation of our planet.

Accordingly, is a need to provide a carriage which is easily collapsible, can be maneuvered with one hand and can collapse into a small package. There is a further need to provide an environmentally friendly carriage.

### OBJECT OF THE INVENTION

It is the object of the present invention to substantially overcome or ameliorate one or more of the disadvantages of the prior art or at least provide a useful alternative.

### SUMMARY OF THE INVENTION

One aspect of the present invention provides a carriage including:

a frame collapsible from an open configuration to a closed configuration, the frame having a base supported by wheels and a pair of longitudinally extending side members attached to the base, each side member having a major direction of extension with the directions being generally parallel and extending upward and rearward with respect to the base;

locking means for securing the frame in the open configuration;

a handle extending between the side members and remote the base, the handle operatively associated with the locking means for unlocking the frame; and

carrying means securable to the frame to carry an item to be transported, wherein the handle is pivotably connected to one said side member such that in use, the handle upon actuation by a user unlocks the locking means moving the frame from the open configuration to the closed configuration and wherein in the closed configuration the handle is substantially parallel and adjacent the side members.

Preferably, the handle defines a longitudinal axis, at least a portion of the handle being rotatable about the axis upon actuation by a user to lock or unlock the frame.

Preferably, each side member includes a first portion and a second portion, each portion pivotably connected together for movement between the open configuration and the collapsed configuration.

Preferably, at least one side member is slideably connected to the handle.

Preferably, the locking means is disposed on at least one side member, wherein the locking means is adapted to secure the frame in tension in the open configuration.

Preferably, the frame is formed from an environmentally sustainable product.

Preferably, the environmentally sustainable product includes bamboo.

Preferably, the carrying means includes fabric suspended between the side members to form an area to receive an object to be transported.

Preferably, the side members include apertures and the fabric includes corresponding buttons whereby in use the fabric can be attached to the frame by inserting a button in its respective aperture.

Preferably, the handle includes a hinge for locking the carriage in the closed configuration.

Preferably, the wheels include a front set of wheels and a rear set of wheels, the front set of wheels including a first wheel and a second wheel, each respective wheel being pivotably attached to the base.

Preferably, the carriage includes a plurality of flat sheet metal fittings for securing each wheel to the base.

Preferably, the carriage is a stroller.

Another aspect of the present invention provides a method of collapsing a carriage from an open configuration to a closed configuration, the carriage having a frame, the frame including a base supported by wheels and a pair of longitudinally extending side members attached to the base, each side member having a major direction of extension with the directions being generally parallel and extending upward and rearward with respect of the base, a handle extending between the side members and remote the base, the handle having a longitudinal axis, the method including the steps of:

rotating a portion of the handle about the longitudinal axis to unlock the frame and release the frame from tension;

urging the handle in the direction of travel of the carriage and simultaneously sliding one side member along the handle toward the other side member;

pivoting the side members downward toward the base to be adjacent the base; and

pivoting the handle 90 degrees to be adjacent and parallel to the side members to lock the stroller in the closed configuration.

### BRIEF DESCRIPTION OF THE DRAWINGS

A preferred embodiment of the present invention will now be described, by way of an example only, with reference to the accompanying drawings wherein:

FIG. 1 illustrates a front perspective view of a preferred embodiment of the stroller according to the present invention;

FIG. 2 illustrates a side perspective view of the stroller shown in FIG. 1;

FIG. 3 illustrates a front view of the stroller shown in FIG. 1;

FIG. 4 illustrates a side view of the stroller shown in FIG. 1;

FIG. 5 illustrates a top view of the stroller shown in FIG. 1;

FIG. 6 illustrates front perspective view of the stroller in FIG. 1, collapsed;

FIG. 7 illustrates a top view of the stroller in FIG. 1, collapsed;

FIG. 8 illustrates a side view of the stroller in FIG. 1, collapsed;

FIG. 9 illustrates a perspective view of the stroller during collapsing;

FIG. 10 illustrates a perspective view of the stroller during collapsing;

FIG. 11 illustrates a perspective view of the stroller during collapsing;

FIG. 12 illustrates a partial perspective view of the handle in the collapsed configuration;

FIG. 13 illustrates a side view of a wheel of the stroller in FIG. 1; and

FIG. 14 illustrates a side view of a wheel of the stroller in FIG. 1.

### DETAILED DESCRIPTION OF THE PREFERRED EMBODIMENTS

There is disclosed herein a carriage for transporting an item, and in particular a collapsible stroller for transporting a toddler or a small child. There is also disclosed herein a method of collapsing a carriage from an open expanded configuration to a closed collapsed configuration, and in particular collapsing a stroller from an open expanded configuration to a closed collapsed configuration.

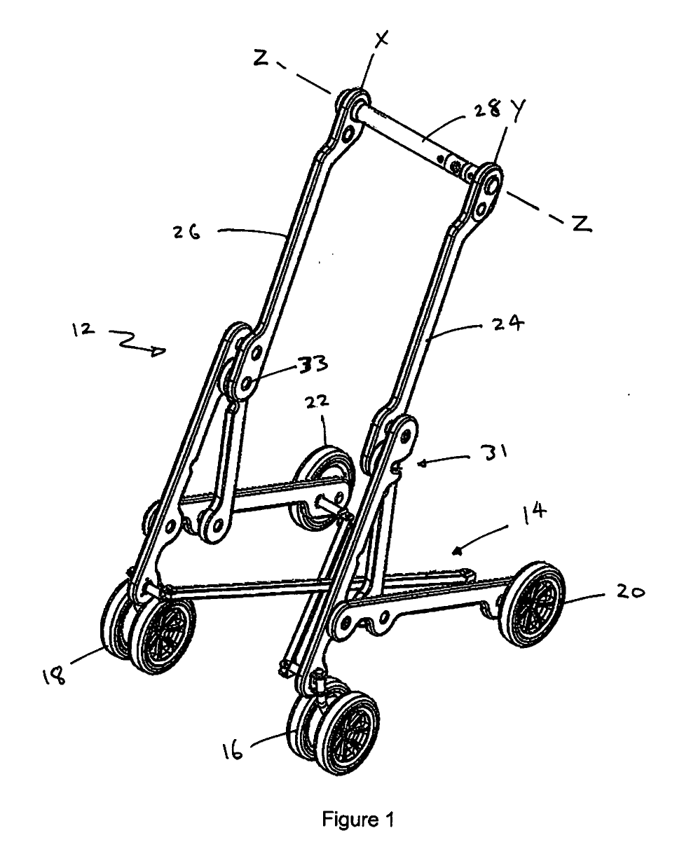

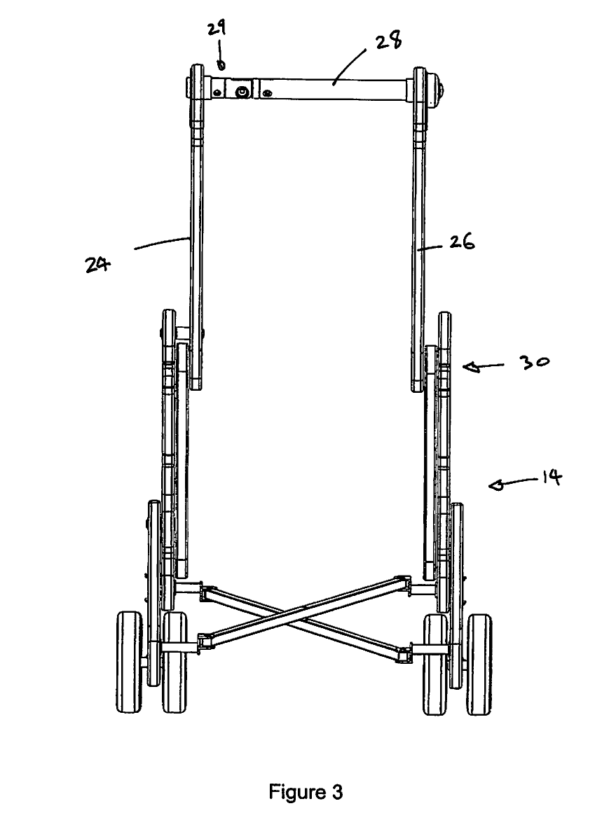

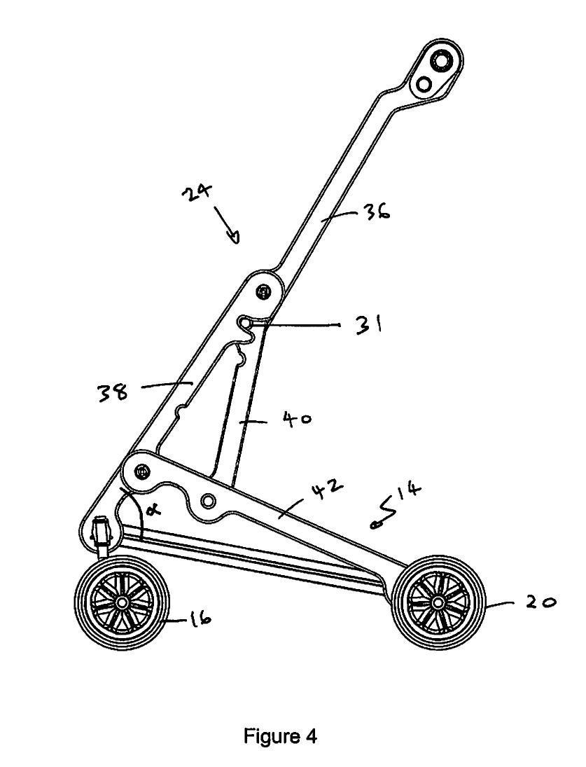

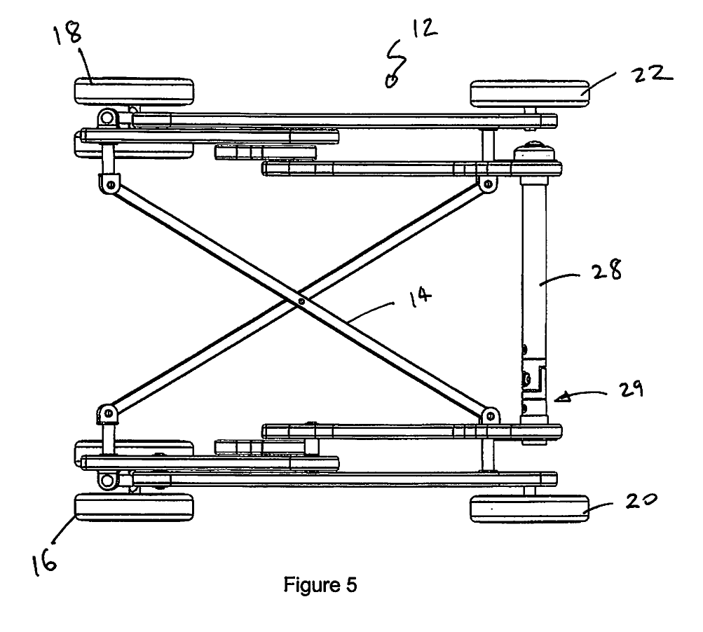

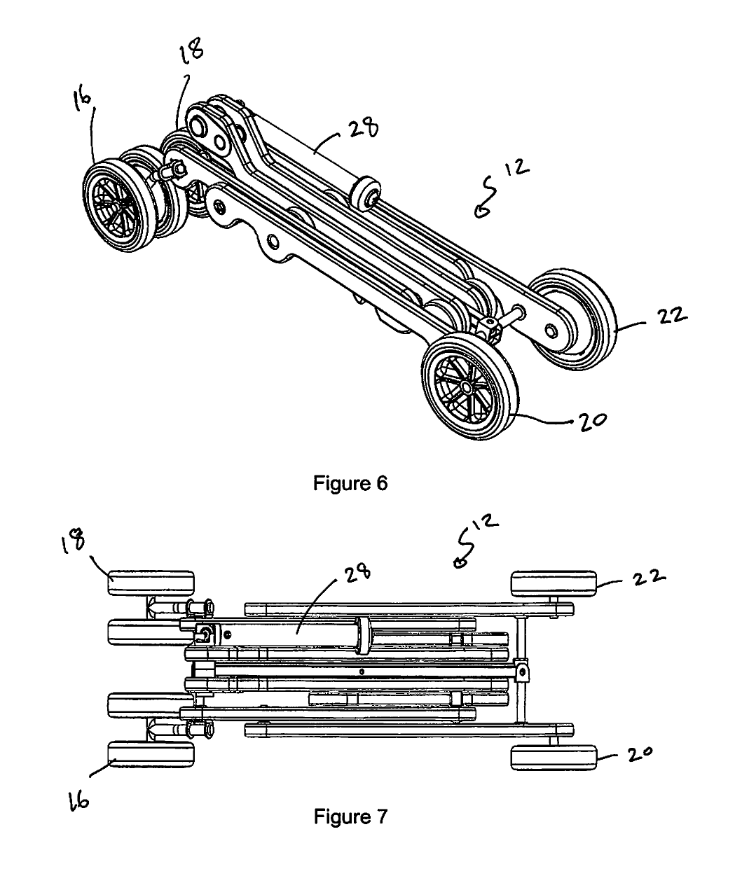

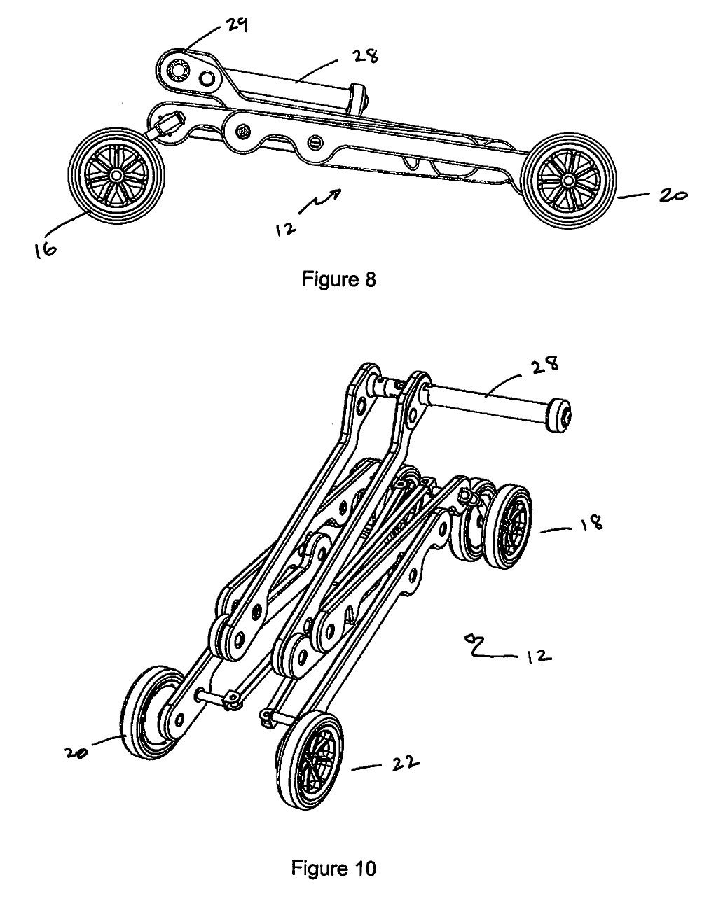

The stroller includes a collapsible frame 12 and a seat (not shown) secured to the frame 12 in a manner such that the child is supported in a seated position and facing forward while travelling. The frame 12 can be formed from compressed bamboo sheeting or other suitable sustainable natural product such as recycled metal, environmentally friendly medium-density fibreboard (MDF) made of recovered wood fibers, recycled high-density polyethylene (HDPE), other sustainably forested wood or the like. The frame 12 includes multiple parts that can be arranged and retained in the open configuration as shown in FIGS. 1 to 5 or folded and retained in the closed configuration for storage as shown in FIGS. 6 to 8.

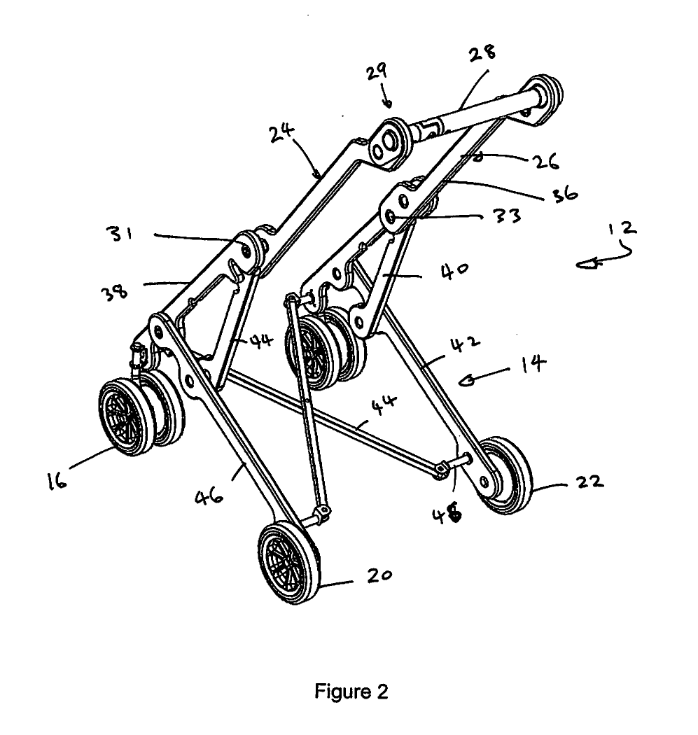

The frame 12 includes a base 14 supported by wheels 16, 18, 20, 22. In the preferred embodiment the base 14 is supported by a pair of front wheel assemblies 16, 18 and a pair of rear wheel assemblies 20, 22. However it is to be understood that other wheel arrangements are possible such as one wheel attached at the front of the base 14 and two wheels attached at the rear of the base 14, or any other combination of wheels. Each wheel 16, 18, 20, 22 is attached to the base 14 using flat sheet metal fittings (not shown) or the like. The frame 12 includes a pair of longitudinally extending side members 24, 26. Each side member 24, 26 is attached to the base 14 and has a major direction of extension X, Y with the directions X, Y being generally parallel and extending upward and rearward with respect to the base 14. That is, in the open configuration, as seen in FIGS. 1 and 2, the side members 24, 26 form an acute angle α with the base 14. For example, the side members 24, 26 could extend rearward with respect to the direction of travel from the front of the base 14 or the rear of the base 14. Each side member 24, 26 includes multiple portions 36, 38, 40, 42, 44, 46 that are moveably interconnected with one another for arrangement in the open configuration and the closed configuration.

The stroller 10 includes a locking means 30 for securing the frame 12 in the open configuration. The locking means 30 includes a pin 31, 33 on each side member 24, 26. Each pin 31, 33 connects the respective portions 36, 38, 40, 42, 44, 46 of each side member 24, 26 such that in the open configuration the frame 12 is in tension.

A handle 28 extends between the side members 24, 26 and is disposed remote the base 14. The handle 28 is operatively associated with the locking means 30 for unlocking the frame 12. The handle 28 is pivotally connected at one end 29 to one side member 24 such that in the closed configuration the handle 28 is substantially parallel and adjacent the side members 24, 26.

Preferably, at least a portion of the handle 28 is rotatable about the axis Z such that a user can single-handedly unlock the frame 12 by rotating the portion of the handle 28 and urging the handle 28 in the direction of travel to release the frame 12 from tension. This will allow the user to close the stroller 10 with one hand.

The stroller 10 includes carrying means (not shown) secured to the frame 12. In the preferred embodiment a seat (not shown) is formed by suspending a piece of fabric between the side members 24, 26. The carrying means does not have to be a seat and can be any form of enclosure for carrying an item. The carrying means can also be made from tropical hemp/cotton fabric, organic cotton fabric, bamboo cotton fabric, fabric made from recycled plastic, recycled poly or the like. Various methods may be used to attach the fabric to the frame 12. For example, each side member 24, 26 may include a plurality of apertures (not shown), and the fabric may include button-style attachments corresponding to the apertures. The fabric can be pulled tightly into position by inserting each button into its respective aperture. Other possible methods of attachments include hook and loop type fasteners, latches, studs or the like.

Preferably, the handle 28 includes a hinge (not shown) to lock the stroller 10 in the closed position.

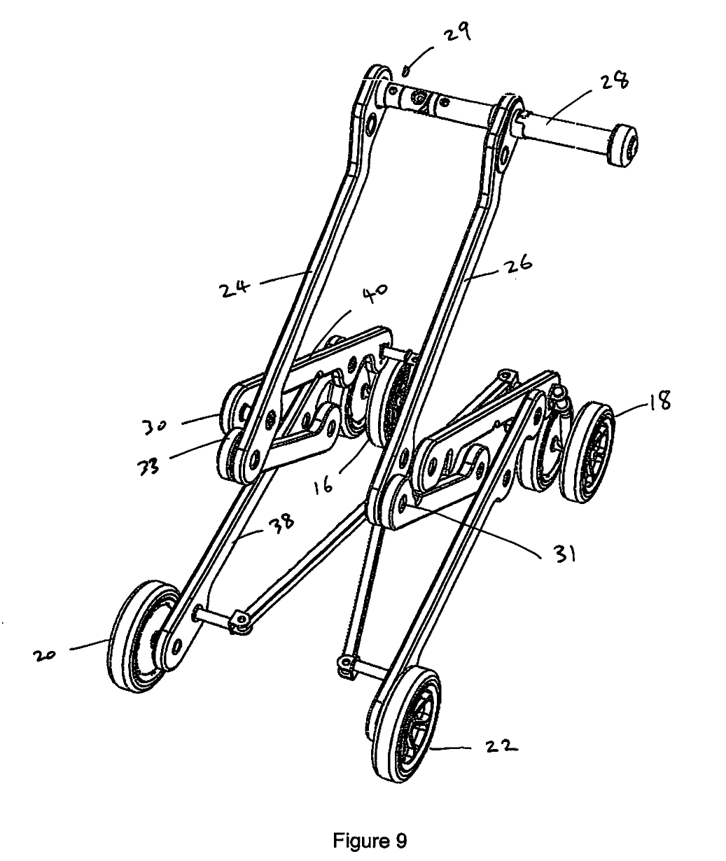

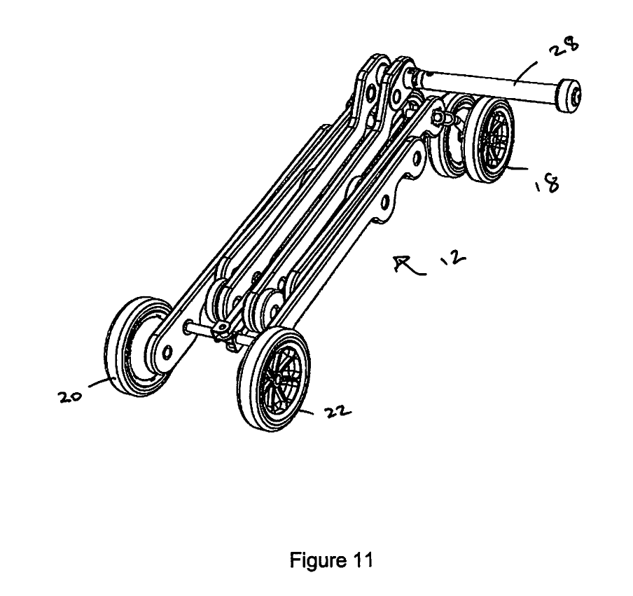

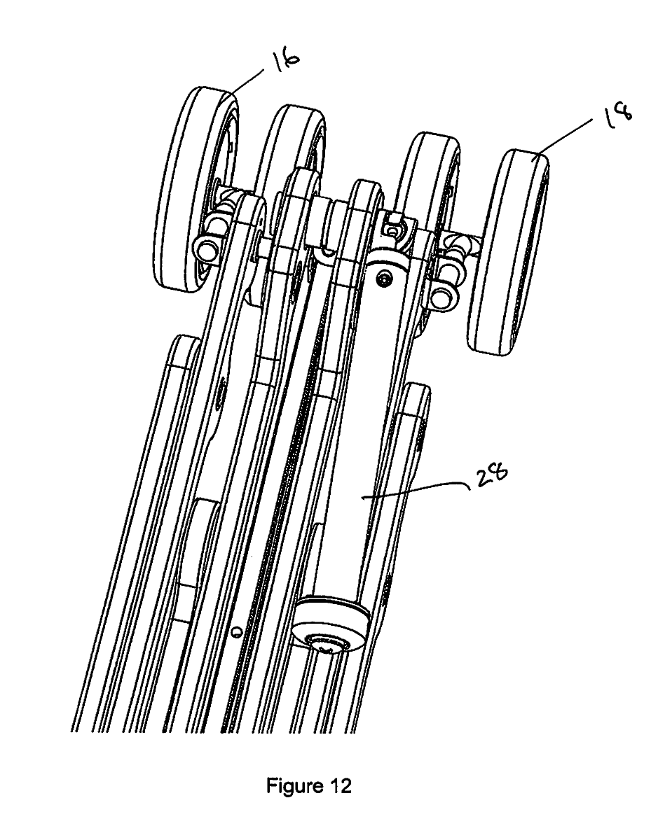

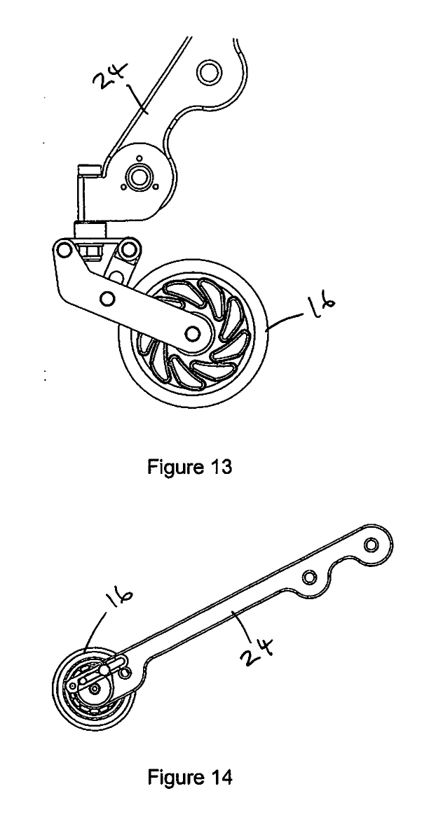

As best illustrated in FIGS. 9 to 12, the stroller 10 can be collapsed from an open configuration to a closed configuration by:

rotating a portion of the handle 28 about axis Z to unlock the frame 12;

urging the handle 28 in the direction of travel and simultaneously sliding one side member 24 along the handle 28 toward the other side member 26;

pivoting the side members 24, 26 downward toward the base 14 to be adjacent the base 14; and

pivoting the handle 28 about 90 degrees to be adjacent and parallel to the side members 24, 26 to lock the stroller 10 in the closed configuration.

To expand the stroller 10 from the closed configuration to the open configuration, the steps above are repeated in reverse.

One advantage of at least a preferred embodiment of the invention is that the construction of the stroller 10 allows for easy assembly and disassembly. Another advantage of the stroller 10 at least in a preferred embodiment of the invention is that it can easily be converted into a scooter for older children or a walker for elderly people. For example, the frame 12 can be disassembled and used as a foot rest, and the wheels 16, 18, 20, 22 can be attached at the handle 28 to form the scooter.

Another advantage of at least a preferred embodiment of the invention is that the stroller 10 has a reduced impact on the environment. The material, design and manufacturing process of the stroller 10 take into account the full life cycle of a product. When possible, environmentally sustainable materials are used. For example, the frame 12 can be made from MDF, HDPE or other sustainably forested wood or the like, and the carrying means (not shown) can be made from tropical hemp/cotton fabric, organic cotton fabric, bamboo cotton fabric, fabric made from recycled plastic, recycled poly or the like. The stroller 10 has been designed to ensure minimal tooling and machinery is required to fabricate and assembly, thus utilizing lower energy in production. For example, the fittings (not shown) reflect a 2D perspective, thus allowing for computer pneumatic control in cutting.

A further advantage of at least a preferred embodiment of the invention is that the flat bamboo frame allows for more compact folding, with the fabric being held tightly within the sides of the frame 12.

Although the invention has been described with reference to a specific example, persons skilled in the art will appreciate that the invention can be embodied in many other forms such as a carriage for transporting groceries and the like. Alternative embodiments include an adult pusher or walker, a children's toy stroller 10 or walker, a shopping trolley, or the like.

While the above description contains many specifics, those specifics should not be construed as limitations on the scope of the disclosure, but merely as exemplifications of preferred embodiments thereof. Those skilled in the art will envision many other possible variations that are within the scope and spirit of the disclosure as defined by the claims appended hereto.

What is claimed is:

1. A carriage including:
a frame collapsible from an open configuration to a closed configuration, the frame having a base supported by wheels and a pair of longitudinally extending side members attached to the base, each side member having a major direction of extension with the directions being generally parallel and extending upward and rearward with respect to the base;
locking means for securing the frame in the open configuration;
a handle extending between the side members and remote the base, the handle operatively associated with the locking means for unlocking the frame; and
carrying means securable to the frame to carry an item to be transported, wherein the handle is pivotably connected to one said side member such that in use, the handle upon actuation by a user unlocks the locking means moving the frame from the open configuration to the closed configuration and wherein in the closed configuration the handle is substantially parallel and adjacent the side members.

2. The carriage of claim 1, wherein the handle defines a longitudinal axis, at least a portion of the handle being rotatable about the axis upon actuation by a user to lock or unlock the frame.

3. The carriage of claim 1, wherein each side member includes a first portion and a second portion, each portion pivotably connected together for movement between the open configuration and the collapsed configuration.

4. The carriage of claim 1, wherein at least one side member is slideably connected to the handle.

5. The carriage of claim 1, wherein the locking means is disposed on at least one side member, wherein the locking means is adapted to secure the frame in tension in the open configuration.

6. The carriage of claim 1, wherein the frame is formed from an environmentally sustainable product.

7. The carriage of claim 1, wherein the environmentally sustainable product includes bamboo.

8. The carriage of claim 1, wherein the carrying means includes fabric suspended between the side members to form an area to receive an object to be transported.

9. The carriage of claim 8, wherein the side members include apertures and the fabric includes corresponding buttons whereby in use the fabric can be attached to the frame by inserting a button in its respective aperture.

10. The carriage of claim 1, wherein the handle includes a hinge for locking the carriage in the closed configuration.

11. The carriage of claim 1, wherein the wheels include a front set of wheels and a rear set of wheels, the front set of wheels including a first wheel and a second wheel, each respective wheel being pivotably attached to the base.

12. The carriage of claim 11, wherein the carriage includes a plurality of flat sheet metal fittings for securing each wheel to the base.

13. The carriage of claim 1, wherein the carriage is a stroller.

14. A method of collapsing a carriage from an open configuration to a closed configuration, the carriage having a frame, the frame including a base supported by wheels and a pair of longitudinally extending side members attached to the base, each side member having a major direction of extension with the directions being generally parallel and extending upward and rearward with respect of the base, a handle extending between the side members and remote the base, the handle having a longitudinal axis, the method including the steps of
rotating a portion of the handle about the longitudinal axis to unlock the frame and release the frame from tension;
urging the handle in the direction of travel of the carriage and simultaneously sliding one side member along the handle toward the other side member;
pivoting the side members downward toward the base to be adjacent the base; and
pivoting the handle 90 degrees to be adjacent and parallel to the side members to lock the stroller in the closed configuration.
